(19) United States
(12) Patent Application Publication
(10) Pub. No.: US 2002/0177103 A1
(43) Pub. Date: Nov. 28, 2002

(54) Removable dental implant appliance mounting

(76) Inventor: Mark S. Pelak, Cape Coral, FL (US)

Correspondence Address: Allen D. Brufsky, PA, Unit # 80, 10700 Stringfellow Road, Bokeelia, FL, 33922, US

(21) Appl. No.: 10/002,361

(22) Filed: Nov. 23, 2001

Related U.S. Application Data
(60) Provisional application No. 60/293,831, filed on May 25, 2001.

(51) Int. Cl. A61C 8/00

(52) U.S. Cl. 433/173; 433/169

(57) ABSTRACT

An improved dental prostheses includes an implant abutment mounted to an abutment tooth and having an endless O-ring groove formed about the outer axial surface of the implant abutment in a plane generally transverse to the implant abutment axis. The implant abutment has a tapered surface which mates closely with a similarly tapered retainer cavity in the dental prosthesis to frictionally support the same and has a complementary O-ring groove defined in the retainer surface. A resilient O-ring retentive element is fitted over the implant abutment such that the ring cross section is partly received within the implant abutment groove and partly within the retainer groove, thereby forming a resilient interference fit between the dental prosthesis and the implant abutment. The arrangement enables easy removal of the prosthesis for hygiene related activities and application to multiple abutments to support an appliance.

### CROSS-REFERENCE TO RELATED APPLICATIONS

This application claims priority from provisional application No. 60/293831, filed May 25, 2001.

### BACKGROUND OF THE INVENTION

1. Field of the Invention

This invention relates to a mounting for a dental appliance.

2. Description of the Prior Art

This invention is an improvement over that disclosed in U.S. Pat. No. 5,556,280. In that patent, a dental implant is disclosed including an implant abutment threadedly connected to the implant. An abutment is provided which has an extended tapered surface for directly supporting an appliance. The tapered surface is formed to be received in and mate with a complimentary surface formed in an appliance. Thus, the appliance is fully supported by the tapered surface of the abutment and need not depend upon gum tissue for support. This enables design of an appliance to look like a natural tooth or teeth, and to nestle close to the gum to fully conceal the area of abutment affixation and the abutment to provide the look of natural teeth.

First and second coupling means or devices are respectively secured to the abutment and the appliance, which removably retains the appliance on the tapered support surfaces of the abutment. The mating of the tapered support surface of the abutment with the complimentary receiving surface of the appliance accurately guides the coupling means into a coupling relationship to removably retain the appliance. This permits removal of the appliance by the patient for hygienic and tissue stimulation purposes, in the area concealed by the appliance, on a regular tooth brushing schedule.

This invention not only enables the design and placement of false teeth that have a natural appearance in place in the mouth, but also provides ready access to the affixation area. This access not only enables easy removal of the appliance by the patient for gum stimulation and hygienic purposes, but also enables repair and orthodontic restoration of an existing replacement tooth or teeth. The first and second coupling means, respectively secured to the abutment and the appliance, which removably retain the appliance on the tapered support surface of the implant abutment is improved so that the appliance can be more easily removed by the patient itself for increased hygiene.

### SUMMARY OF THE INVENTION

In accordance with the invention, an improved telescope retainer comprises an implant abutment constructed for affixing onto a suitable implant abutment in a patient's mouth. The implant abutment is a structure which tapers in cross-section along an implant abutment axis. The cross sectional shape of the implant abutment may vary according to the shape and size. The implant abutment axis extends between a wider base end and an implant abutment end. The implant abutment has an axial outer surface which tapers in cross sectional perimeter along the axis. An endless groove is formed in the outer axial surface of the implant abutment in a plane generally transverse to the implant abutment axis at a location intermediate the base end and the upper end. An O-ring of elastomeric material is axially retained within the groove. The O-ring has a cross-sectional dimension substantially greater than the depth of the groove so that an outer portion of the ring projects radially from the axial implant abutment surface when the ring is fitted in the groove. A dental prosthesis is removably secured to the coping by providing a retainer cavity in the prosthesis having a retainer surface dimensioned for close telescopic mating with the axial implant abutment surface, and a second groove provided in the telescoping retainer surface is positioned and dimensioned for snuggly receiving the outer portion of the O-ring on the implant abutment. The O-ring thus makes a retentive interference fit between the prosthesis and the implant abutment to supplement the conventional frictional retention between the telescoping surfaces.

### BRIEF DESCRIPTION OF THE DRAWING

Further objects and advantages of the invention will become more apparent from the following description and claims and from the accompanying drawing, wherein:

FIG. 1 is an exploded perspective view of one embodiment of the present invention;

FIG. 2 is an exploded perspective view of a second embodiment of the present invention; and

FIG. 3 is an exploded perspective view of still another embodiment of the present invention.

### DETAILED DESCRIPTION OF THE PREFERRED EMBODIMENTS

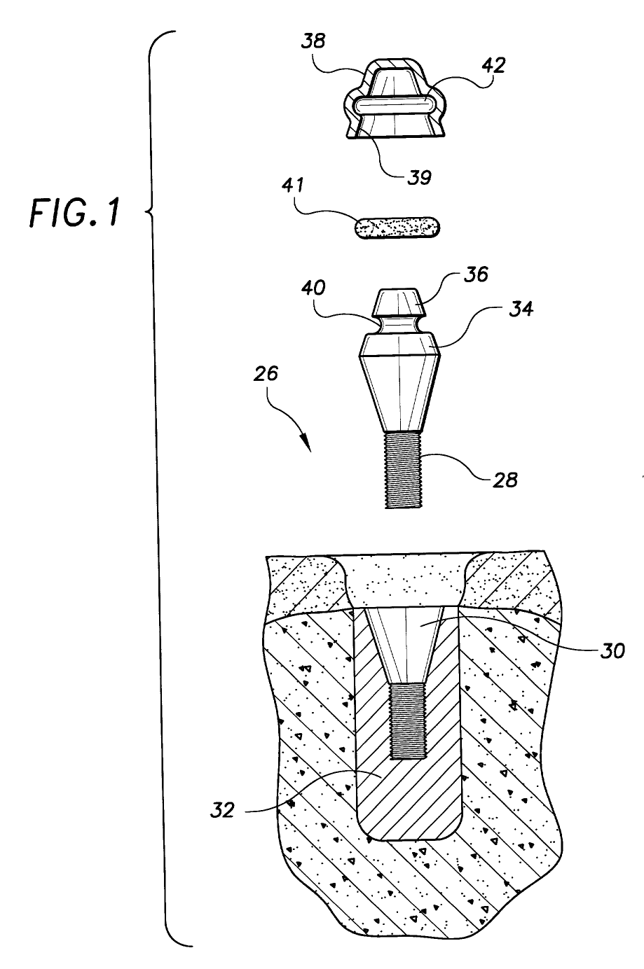

Referring now to the drawings in detail, wherein like numerals indicate like elements throughout the several views, and particularly to FIGS. 1, 2, and 3, a direct overdenture attachment implant abutment, and a crown or bridge implant abutment attachment are illustrated in each Figure.

In FIG. 1, an implant abutment attachment is generally indicated at 26, and has a metal shaft 28, which is threaded to be received in a threaded bore 30 formed in a dental implant 32. A platform 34 carried on top of shaft 28 supports the male half 36 of a coupling means. The platform 34 of the male half of the coupling means has an inward taper extending upwardly to guide the female half 38 or appliance into a coupling relationship.

This inwardly tapered surface of the platform 34 of the male coupling means serves to directly support the appliance 38 by frictional engagement with the interior surface of the downwardly extending tapered skirt portion 39 of the dental appliance above and below a retention device, such as an O-ring 41 removably secured to the overdenture or female half 38 of the coupling. The O-ring 41 inserted is inserted in a groove 40 circumferentially formed in the female half of the coupling and a corresponding circumferential groove 42 in the appliance (e.g., a cap or overdenture) or female half of the coupling 38.

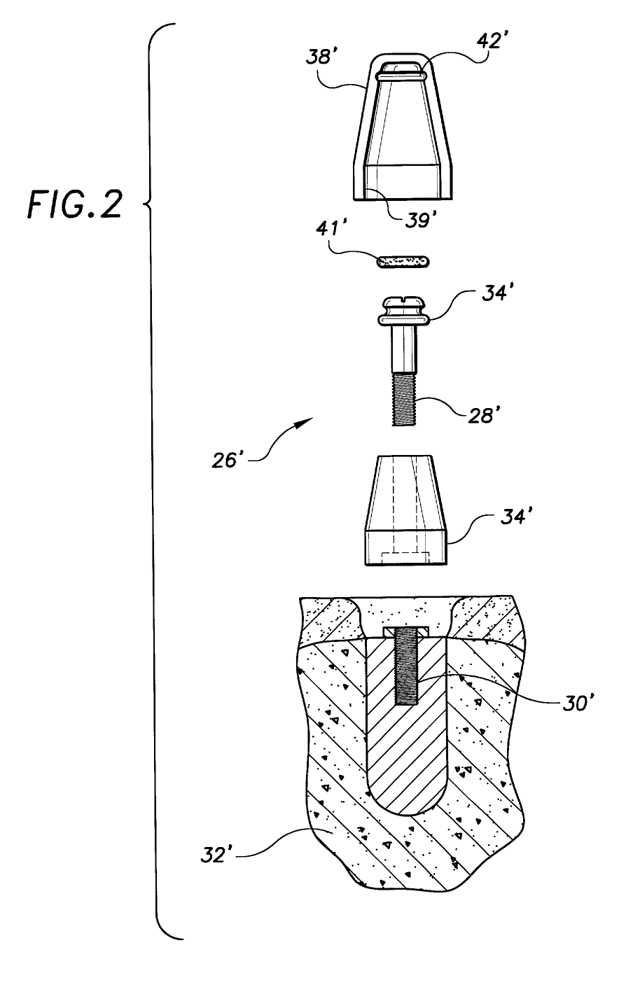

In FIG. 2, an implant abutment attachment is generally indicated at 26′, and has a metal shaft 28′ which is threaded through the implant abutment 26′ and received in a threaded bore 30′ formed in a dental implant 32′. An inwardly tapered surface on the exterior of platform 34′ is carried on top of shaft 28′ which frictionally mates with and supports the downwardly tapering skirt 39′ on the female half 38′ of a coupling means or dental appliance. As with the overdenture attachment in FIG. 1, a gingival cuff of variable height is provided. As in the overdenture of FIG. 1, the implant abutment 26′ has an inward taper extending upwardly to guide and support the cap or dental appliance or female half of the coupling 38′ into a coupling relationship. Again, the retention for the appliance is provided by an O-ring coupling member 41′ inserted between a circumferential groove 40′ formed on top of metal shaft 28′ and a retentive undercut or circumferential groove 42′ in the cap or appliance 38′.

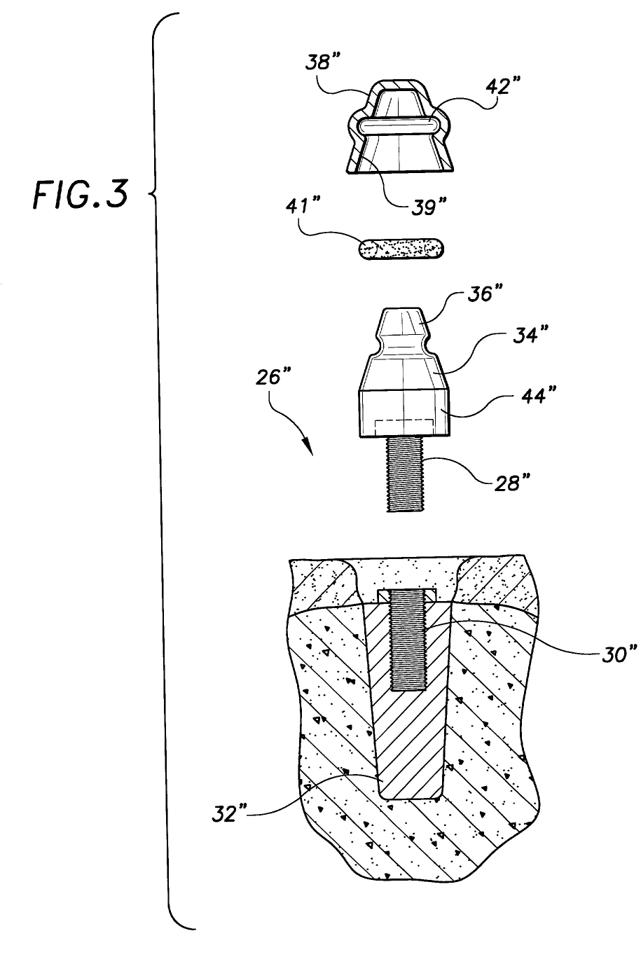

In FIG. 3, (the components of the invention are substantially identical as that shown in FIG. 2, and corresponding elements are indicated by double primed numerals. The only substantial difference between the embodiments of the invention in FIGS. 2 and 3 is that the implant abutment 26″ has a bottom cylindrical portion 44″, rather than a tapered portion for mating engagement with the implant 32″.

The appliances 38, 38′ and 38″ do not need or depend upon gum tissue for support. This enables design of an appliance in which the lower surfaces of the false teeth (or the lower rim of the appliance) will be at or slightly below the gingival margin to make the false teeth look like natural teeth in place in the gums. In addition, the design of the appliance will fully conceal the area of affixation and the abutment members'.

As can be seen, the mating of the tapered support surfaces of the appliance and implant abutment accurately guides the first and second coupling members into a coupling relationship in conjunction the O-ring coupling to removably retain the appliance on the tapered support surfaces. This design permits removal of the appliance by the wearer for hygienic and tissue stimulation purposes in the area concealed by the appliance, without having to make a trip to the dentist and/or can be easily removed by the dentist during routine check-ups.

The male platform member 34, 34′ and 34″ of the male half 36, 36′ and 36″ of the coupling means preferably is formed of a metallic material, such as a metal which conventionally finds use in the field of dentistry. Similarly, the abutment member is also formed of the same metal, usually titanium, particularly if the male member and the abutment member are formed together at the same time as an integral component.

The female half of the coupling member or appliance 38, 38′ and 38″ is also preferably formed of metal, but may be formed of a plastic to be cast in metal for strength. The O-ring retainer is the only part which may need replacement due to wear.

The appliance, may also be a partial denture, and may be formed of a dental acrylic or cast in metal with porcelain fused to it, or a composite baked on to it. The appliance may be removably mounted by a pair of male members which telescopically intercooperate with a pair of female members in mounting the appliance.

The improved appliance is hygienic in that it can be readily cleaned at frequent intervals because of the easy removal. It can also be easily maintained by the patient or dentist through replacement of the O-rings as their condition may require.

I claim:

1. An improved dental prostheses comprising:
an implant abutment affixed at a lower end to a dental implant,
said implant abutment having an implant abutment axis;
a groove in said implant abutment extending substantially transverse to said axis
and O-ring of elastomeric material stretched about said implant abutment and elastically retained in said groove, said O-ring having a cross-sectional diameter substantially greater than the depth of said groove such that an outer portion of said ring projects from said axial implant abutment surface; and
an appliance having a retainer cavity including a retainer surface closely telescopically matable onto said axial implant abutment surface, there being a complementary groove in said retainer surface shaped to closely match and receive said outer portion of the O-ring, said O-ring thus making a resilient retentive fit between said prosthesis and said implant abutment.

2. The prosthesis of claim 1 wherein said implant abutment includes a tapered surface for guiding engagement with said retainer cavity of said appliance.

3. The prosthesis of claim 2 wherein said implant abutment is threadedly connected to said implant.

4. The prosthesis of claim 3 wherein said implant abutment is formed from metal.

5. The prosthesis of claim 4 wherein said appliance is formed from metal, either processed into a denture, partial denture, a splinted bar.

6. The prosthesis of claim 5 wherein said appliance is formed from porcelain fused to metal.

7. An implant dental prosthesis comprising:
an implant abutment affixed at a lower end to a dental implant, said implant abutment having an implant abutment axis, and an appliance having
a hollow retainer cavity with an outwardly and downwardly taper relative to said implant abutment axis forming a retainer surface telescopically mateable on and upwardly and inwardly extending facing tapered surface on said axial implant abutment.

8. The prosthesis of claim 7 wherein said tapered surfaces are in frictional engagement.

9. The prosthesis of claim 8 wherein said retentive element between said mating tapered surfaces.

10. The prosthesis of claim 9 where said retentive element is in a plane generally transverse to the axis of said implant abutment.

11. The prosthesis of claim 10 wherein said retentive element is an O-ring in complementary grooves in said tapered surfaces.
